(19) United States
(12) Patent Application Publication
(10) Pub. No.: US 2001/0033356 A1
(43) Pub. Date: Oct. 25, 2001

(54) Liquid crystal display device

(75) Inventors: Kazuhiko Yanagawa, Mobara (JP); Keiichiro Ashizawa, Mobara (JP); Masahiro Ishii, Mobara (JP); Masayuki Hikiba, Mobara (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd.

(21) Appl. No.: 09/822,175

(22) Filed: Apr. 2, 2001

(30) Foreign Application Priority Data
Apr. 21, 2000 (JP) 2000-121150

(51) Int. Cl. G02F 1/1339

(52) U.S. Cl. 349/153

(57) ABSTRACT

To perform gap definition between respective transparent substrates with increased accuracy and reliability. Adhesion of a specified one of substrates as disposed to oppose each other with a layer of liquid crystal material interposed therebetween to the remaining one of the substrates is made by a sealing material which also has liquid crystal sealing functionality while causing more than one projection body to be disposed within the sealing material along the longitudinal direction of such seal material, wherein this projection body is formed at either one of the respective substrates.

### BACKGROUND OF THE INVENTION

1. Field of the Invention

The present invention relates generally to liquid crystal display devices and, more particularly, to spacers as interposed between respective transparent substrates which are disposed to oppose each other with a layer of liquid crystal material sandwiched therebetween.

2. Description of the Related Art

Letting one or more spacers be interposed between respective transparent substrates disposed opposing each other with a liquid crystal layer sandwiched therebetween makes it possible to make uniform or “uniformarize” the thickness of such liquid crystal layer over the entire area of a display region, thereby improving the quality of display images.

Traditionally these spacers include those that are distributed and interspersed in the display region and others that are mixed into a seal material used for adhesion of one of the transparent substrates to the remaining transparent substrate, wherein the former may typically consist of spherical bead-like members whereas the latter may employ column-shaped fibers.

Unfortunately the above-stated liquid crystal display device is the one that employs respective spacers noted above which are those as have been mixed into the seal material when a pattern of seal material is drawn by a dispenser on one transparent substrate surface or, alternatively, those which have been mixed into a liquid crystal material when encapsulating this liquid crystal material between transparent substrates as formed into a cell-like shape.

Due to this, distribution-nonuniform-portions including coarse or dense portions would readily occur in the interspersion of the spacers, which in turn makes it from time to time impossible to uniformly perform any intended gap definition of respective transparent substrates.

### SUMMARY OF THE INVENTION

The present invention has been made in view of the above technical background and its primary objective is to provide a liquid crystal display device capable of accurately performing the gap definition between respective transparent substrates with increased reliability.

A summary of the representative one of principal concepts of the invention as disclosed herein will be brief ly explained below.

To be brief, a liquid crystal display device in accordance with the instant invention is the one which comprises a pair of substrates as disposed to spatially oppose each other with a layer of liquid crystal material interposed therebetween and a seal material used for adhesion of one of the substrates to a remaining substrate, the seal material also having a function of encapsulating the liquid crystal material, wherein more than one projection body is disposed within the seal material along an extending direction thereof, and that this projection body is formed at either one of the respective substrates.

The liquid crystal display device thus arranged is the one that is fabricated by selective etching techniques using photolithography technologies at one substrate, thus enabling fabrication with any specified height at specified position(s).

Thus it is possible to perform gap definition between respective transparent substrates with increased accuracy and reliability.

### BRIEF DESCRIPTION OF THE DRAWINGS

FIG. 1 is an arrangement diagram showing one embodiment of the liquid crystal display device in accordance with the present invention;

FIG. 2 is a plan view diagram of part of FIG. 1B;

FIG. 3 is a main part plan view diagram showing another embodiment of the liquid crystal display device in accordance with this invention;

FIG. 4 is a main part arrangement diagram showing another embodiment of the liquid crystal display device in accordance with the instant invention;

FIG. 5 is a main part plan view diagram showing another embodiment of the liquid crystal display device in accordance with the invention;

FIG. 6 is a main part plan view diagram showing another embodiment of the liquid crystal display device in accordance with the invention;

FIG. 7 is a main part plan view diagram showing another embodiment of the liquid crystal display device in accordance with the invention;

FIG. 8 is a main part plan view diagram showing another embodiment of the liquid crystal display device in accordance with the invention;

FIG. 9 is a main part plan view diagram showing another embodiment of the liquid crystal display device in accordance with the invention;

FIG. 10 is a plan view diagram showing another embodiment of the liquid crystal display device in accordance with the invention;

FIG. 11 is a main part sectional view diagram showing another embodiment of the liquid crystal display device in accordance with the invention;

FIG. 12 is a main part sectional view diagram showing another embodiment of the liquid crystal display device in accordance with the invention;

FIG. 13 is a main part sectional view diagram showing another embodiment of the liquid crystal display device in accordance with the invention;

FIG. 14 is a plan view diagram of a liquid crystal display device also embodying the invention;

FIG. 15 is a main part sectional view diagram showing another embodiment of the liquid crystal display device in accordance with the invention;

FIG. 16 is a process flow diagram showing one embodiment of a method for manufacturing a liquid crystal display device in accordance with this invention;

FIG. 17 is a process flow diagram showing another embodiment of the liquid crystal display device manufacturing method in accordance with the invention;

FIG. 18 is a main part sectional view diagram showing another embodiment of the liquid crystal display device in accordance with the invention; and

FIG. 19 is a main part sectional view diagram showing another embodiment of the liquid crystal display device in accordance with the present invention.

### DESCRIPTION OF THE PREFERRED EMBODIMENTS

Several preferred embodiments of the liquid crystal display device in accordance with the present invention will now be explained by use of the accompanying figures of the drawing below.

Embodiment 1:

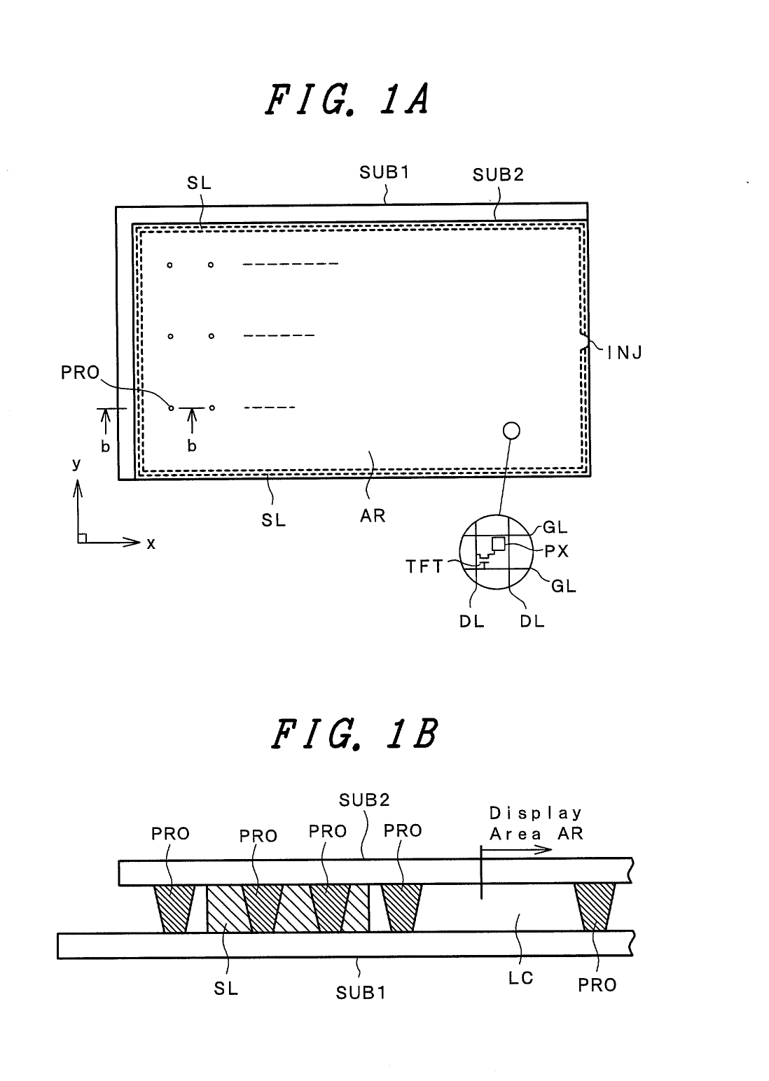

FIG. 1A shows a plan view diagram showing one embodiment of the liquid crystal display device of this invention, a cross-sectional view of which device as taken along line b-b herein is shown in FIG. 1B.

In FIG. 1A, there is a transparent substrate SUB1, and there is a remaining transparent substrate SUB2 which is disposed opposing this transparent substrate SUB1.

The transparent substrate SUB2 is formed so that it is slightly smaller in size than the transparent substrate SUB1; for example, its lower side edge and right side edge are flush with each other.

Due to this, while each periphery of the transparent substrate SUB1's upper side edge and left side edge has a portion exposed from the transparent substrate SUB2, this portion is used for layout of terminals of signal lines for supplement of signals to respective picture elements or “pixels” of a display section as will be described later or alternatively mounting of one or more built-in driver circuits (semiconductor ICs) as connected to these terminals.

A layer of liquid crystal material LC is interposed or “sandwiched” between the transparent substrate SUB1 and the transparent substrate SUB2, wherein this liquid crystal LC is encapsulated by a seal material SL that is formed on the entire area at the periphery of transparent substrate SUB2.

The seal material SL also has a function of adhering the transparent substrate SUB2 with respect to the transparent substrate SUB1 and is arranged to have at its part an encapsulation inlet port INJ for encapsulating the liquid crystal LC, wherein this encapsulation inlet port INJ is arranged so that it is sealed by a sealing material after completion of encapsulation of the liquid crystal LC through this encapsulation inlet port INJ.

A region surrounded by the seal material SL, that is, a region with the liquid crystal LC laid therein becomes a display region AR, wherein this display region AR is formed of a collection or “ensemble” of a great number of pixels that are disposed into a matrix form.

Each pixel has a built-in electronic circuit whose equivalent circuitry is as shown for example in FIG. 1A.

In FIG. 1A, a region that is surrounded by gate signal lines GL extending in an “x” direction and being disposed in parallel with “y” direction in the drawing and drain signal lines DL extending in the y direction and being laid out in parallel with the x direction is arranged as a pixel region: in this region, a thin-film transistor TFT as driven by a scan signal being supplied from a gate signal line GL and a pixel electrode PX to which a video image signal is supplied from a drain signal line DL are formed.

While this pixel electrode PX is designed to permit creation of an electrical field between itself and its opposite electrode, also known as “counter” electrode among those skilled in the art, with a reference voltage being applied thereto to thereby control optical transmissivities of liquid crystals by this electric field, such counter electrode is formed for example on the side of the other transparent substrate SUB2 opposing the transparent substrate SUB1 with the pixel electrode PX formed thereon; in the case of a lateral electric field scheme, it is formed on the side of the transparent substrate SUB1 with the pixel electrode PX formed thereon.

The gate signal lines GL and drain signal lines DL are designed to extend beyond the seal material SL up to the left side edge and upper side edge of the transparent substrate SUB1 for electrical connection to the terminals stated supra.

And, projection bodies PRO having functions as spacers are formed between the transparent substrate SUB1 and the transparent substrate SUB2 for uniformly retaining a gap as defined therebetween to thereby constantly maintain the thickness of the liquid crystal layer LC.

This projection bodies PRO are formed for example on the transparent substrate SUB2 side and are the ones that are fabricated by applying selective etching treatment using photolithography techniques to a resin film which has been uniformly formed on a specified surface of the transparent substrate SUB2 on the liquid crystal LC side by way of example.

Due to this, these projection bodies PRO may offer an advantage of enabling accurate formation with a prespecified thickness at desired locations.

In addition, as shown in FIG. 1B, these respective projection bodies PRO are formed so that these are interspersed within the display region AR and also formed in a region used for formation of the seal material SL.

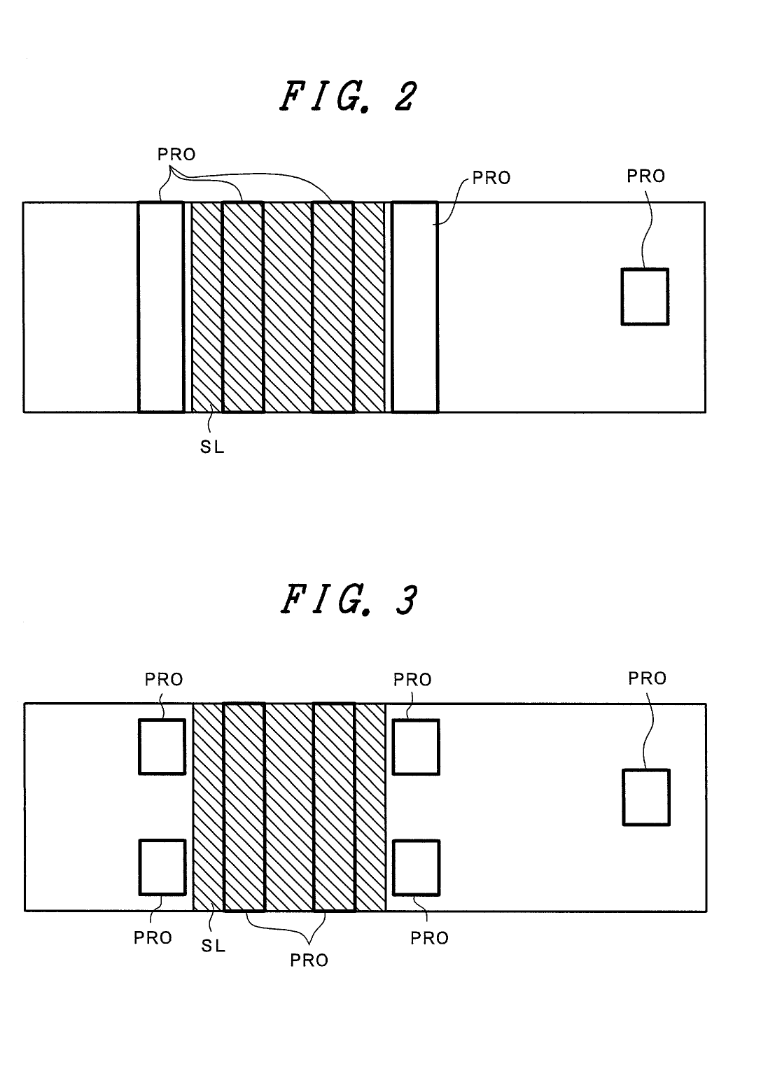

See FIG. 2, which is a plan view diagram enlargedly showing the seal material SL formation part. As apparent from viewing this diagram, four projection bodies PRO are formed in the seal material SL formation (deposition) region and its nearby portions in such a manner that they are in parallel with one another along the seal material SL formation region, wherein two inside projection bodies PRO thereof are formed to be buried within the seal material.

With such an arrangement, the resultant gap as defined between respective transparent substrates SUB1, SUB2 at part adjacent to the seal material SL is accurately retained by the four respective projection bodies PRO with high precision while at the same time permitting rigid adhesion of the transparent substrate SUB2 to the transparent substrate SUB1 by the seal material SL.

See also FIG. 3, which is a diagram corresponding to FIG. 2 and showing another embodiment different from the above-described embodiment.

The embodiment shown herein is such that the projection bodies PRO as formed on the both sides of the seal material SL are not a continuous one along this seal material SL but the ones which are formed discontinuously or intermittently.

Embodiment 2:

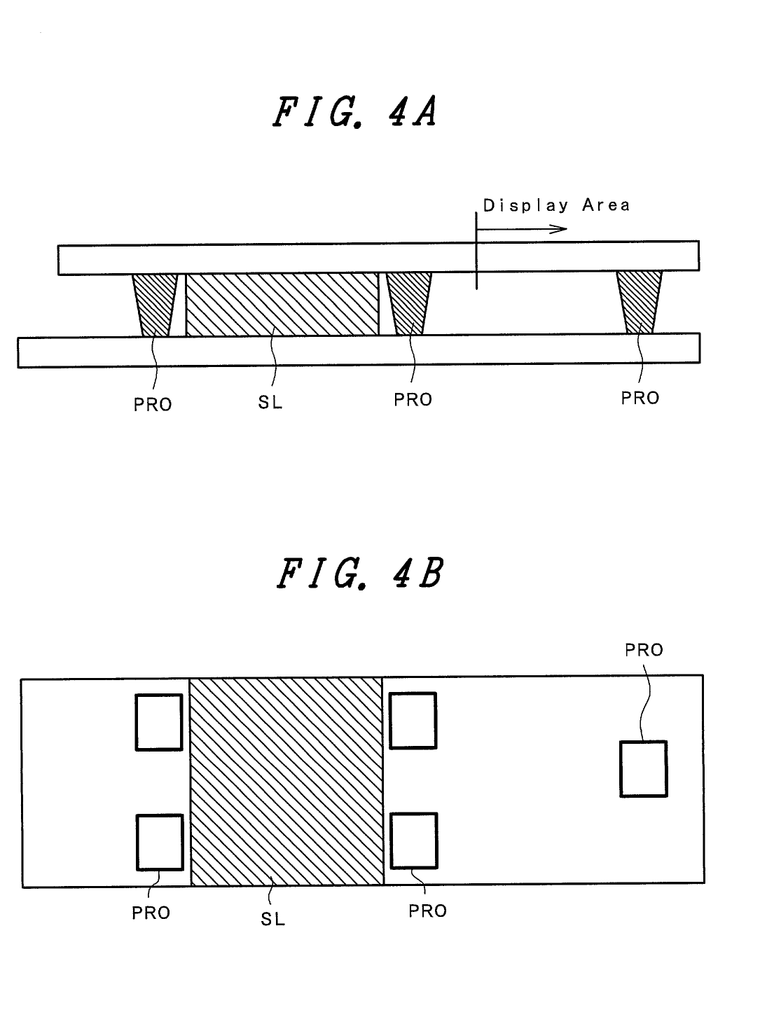

FIG. 4A is a cross-sectional view diagram showing another embodiment of the liquid crystal display device in accordance with the present invention, whose plan view is shown in FIG. 4B.

FIG. 4B is a diagram showing a seal material SL formation region and its nearby part, wherein the seal material SL formation region and the projection body PRO formation region are formed separately from each other.

In other words, none of the projection bodies PRO are formed in the seal material SL formation region; the projection bodies PRO are formed on the both sides of the seal material SL along the extending or elongate direction of the seal material SL, respectively.

The reason for employing such arrangement is that an attempt is made to reduce the resistance of the seal material SL due to the presence of the projection bodies PRO to thereby shorten a time taken to complete the gap definition, thus improving the manufacturing efficiency.

In this case, the respective projection bodies PRO are formed not as the ones that are continued along the elongate direction of the seal material SL but as the discontinuous or intermittent ones due to the fact that they tend to slightly spread to the width direction thereof during gap definition.

This can be said because the seal material SL's along-the-width spread or expansion is not disturbed by the projection bodies PRO.

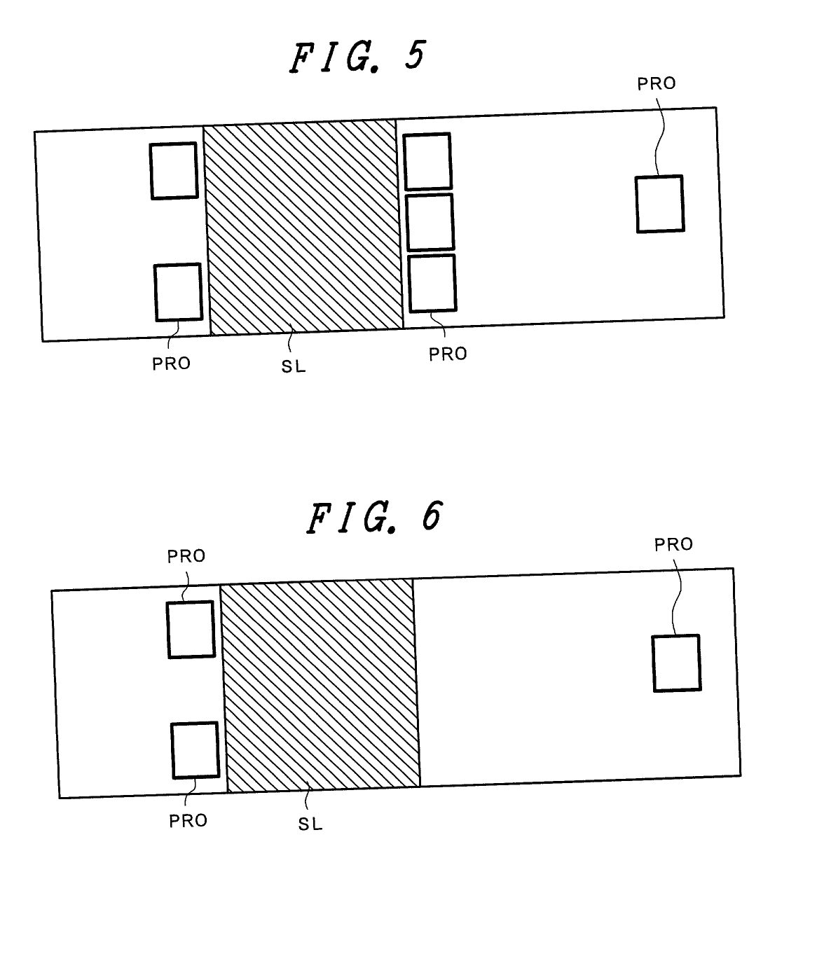

FIG. 5 is a plan view diagram showing another embodiment, which is the diagram corresponding to FIG. 4B.

An arrangement different from that shown in FIG. 4B is that respective projection bodies PRO are formed while letting the distance of respective spaced-apart intermittent projection bodies PRO on the display region AR side with respect to the seal material SL be greater than the distance of respective intermittent projection bodies PRO on the opposite side of the display region AR.

In the case of employing this arrangement, it is possible to make easier the seal material SL's spread in its one width direction, thereby making it possible to shorten the time as taken to complete the gap definition.

In addition, FIG. 6 is a plan view diagram showing another embodiment, which is the diagram corresponding to FIG. 5.

An arrangement different from that shown in FIG. 5 is that only the discontinuous projection bodies PRO on the opposite side of the display region AR are provided with respect to the seal material SL without providing the intermittent projection bodies PRO on the display region AR side.

In the case of using this arrangement, the projection bodies PRO for the purposes of gap definition at nearby part of the seal material SL consist of intermittent projection bodies PRO on the opposite side of the display region AR with respect to the seal material SL and projection bodies PRO as interspersed within the display region AR, resulting in an increase in distance between the projection bodies PRO which are on the both sides of the seal material SL.

Due to this, it offers an effect of enabling softening or relaxation of any possible gap irregularities at peripheral portions of the seal material SL.

Embodiment 3:

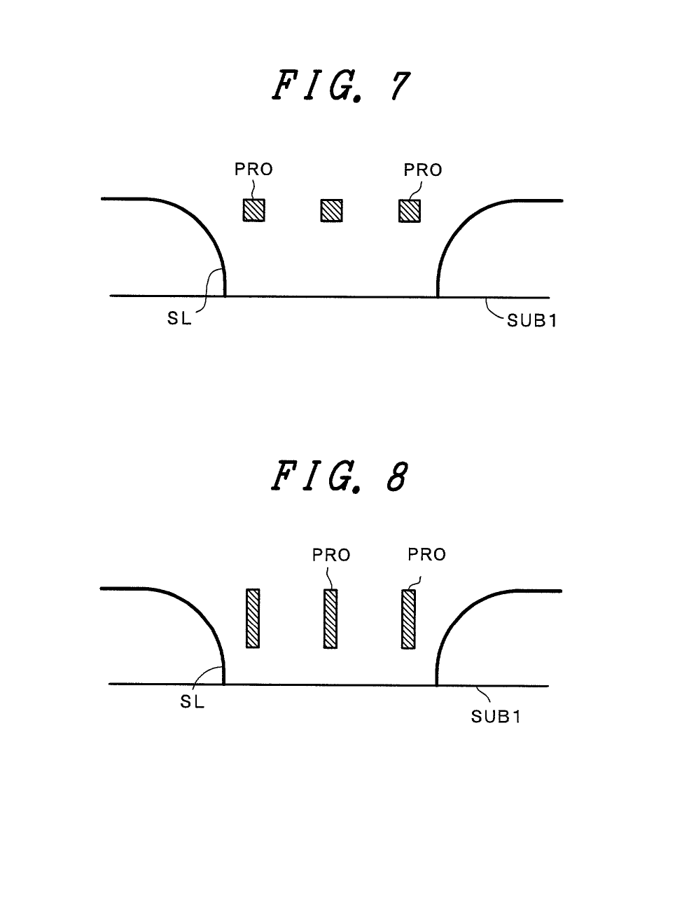

FIG. 7 is a plan view diagram showing another embodiment of the liquid crystal display device in accordance with the present invention, which is the one showing nearby part of a liquid crystal encapsulating section of the seal material.

In FIG. 7 the seal material SL is formed at its liquid crystal encapsulation inlet port INJ so that it extends toward an edge face of the transparent substrate SUB1 thereby making easier a process of sealing the liquid crystal material LC used.

And, a plurality projection bodies PRO are formed near or around a liquid crystal encapsulation section INJ thereof in such a manner that they are laid out over an extension line of another seal material SL other than the seal material SL which constitutes the liquid crystal encapsulation section.

These projection bodies PRO are the ones that are simultaneously formed during fabrication of the projection bodies PRO as interspersed in the display region AR by way of example, and are the ones as formed on one transparent substrate SUB2.

In view of the fact that the projection bodies PRO are to be formed through selective etch processes using photolithography techniques, it is advantageously possible to accurately control the distance between adjacent ones of respective projection bodies PRO along with the area thereof.

FIG. 8 is a plan view diagram showing another embodiment, which corresponds to FIG. 7. An arrangement different from that shown in FIG. 7 is that each projection body PRO is formed to have a rectangular shape as extended in a direction substantially at right angles to an edge face of the transparent substrate SUB1.

Each the projection body PRO thus formed comes to have a role of smoothly guiding toward the display region AR when encapsulating the liquid crystal material LC.

And, while these projection bodies are capable of accurately performing gap definition between respective transparent substrates SUB1, SUB2 at the liquid crystal encapsulation section INJ in a way similar to that of respective projection bodies PRO shown in FIG. 7, the arrangement shown in FIG. 8 further offers an ability to make it accurate and rigid with enhanced strength.

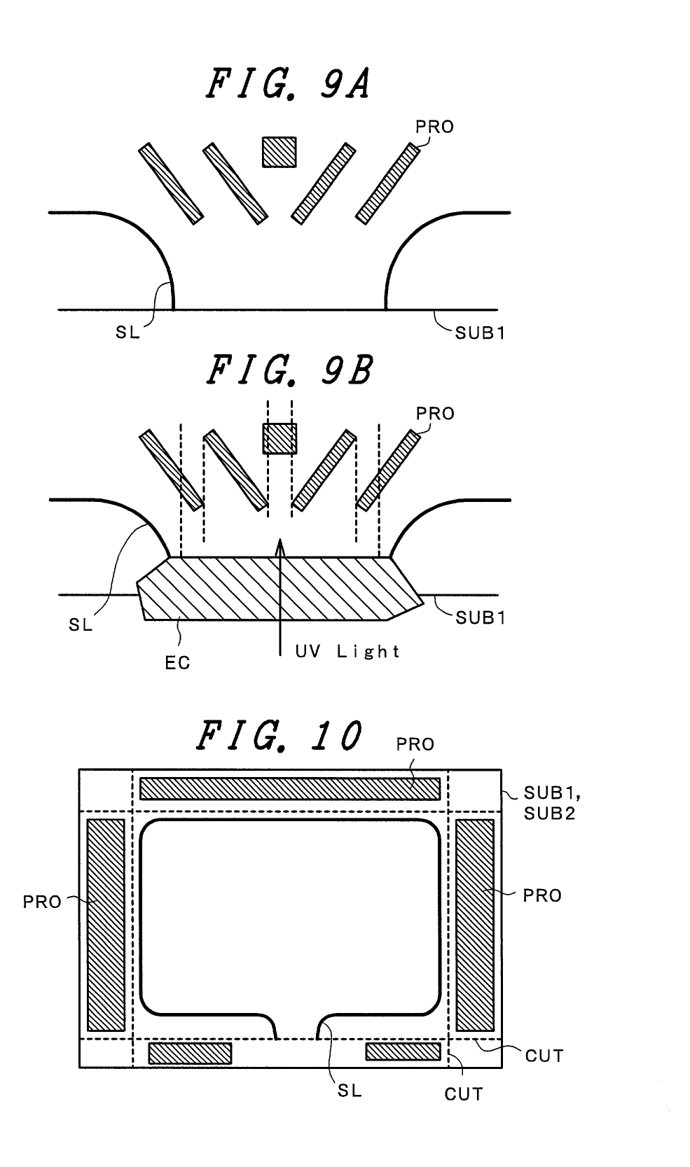

FIG. 9 is a plan view diagram showing another embodiment, which corresponds to FIG. 8. An arrangement different from that shown in FIG. 8 is that each projection body PRO is disposed radially when looking at from the encapsulation side of liquid crystal material while at the same time being laid out so that the back section side of the projection body PRO is incapable of being viewed.

In other words each projection body PRO is disposed so that it is capable of blocking or “shielding” rays of light coming from more than one liquid crystal encapsulation hole.

With such an arrangement, in the case of hardening a UV-hardenable material EC used to block the encapsulation hole after having encapsulated the liquid crystal material, UV rays will no longer be fall onto liquid crystals even when such UV rays are irradiated from the encapsulation side.

In view of the fact that liquid crystals inherently have the nature that they are discomposed by UV rays resulting in occurrence of deleterious changes in quality, the use of the arrangement stated above makes it possible to preclude such deterioration of liquid crystals.

Embodiment 4:

FIG. 10 is a plan view diagram showing another embodiment of the liquid crystal display device in accordance with the present invention.

The liquid crystal display device shown herein is the one that was made based on execution of a process including the steps of preparing, in the manufacture thereof, respective transparent substrates SUB1, SUB2 of relatively large sizes, machining them to cause them to arrange cells through seal material SL, and thereafter cutting into specified sizes (indicated by “CUT” in FIG. 10).

More specifically, this is in place of the approach to forming the projection bodies PRO to be formed in the seal material SL formation region or at its nearby region(s) at peripheral part adjacent to the edges of respective transparent substrates SUB1, SUB2, i.e. specific portions of the transparent substrates to be cut away after having arranged the cells required.

Since the projection bodies PRO in this case are less in elements that are spatially precluded or disturbed, it is possible to form the widths thereof relatively significantly whereby it becomes possible to accurately perform the gap definition at such part without having to especially form any projection bodies to be formed in the seal material SL formation region or at its nearby region(s).

Embodiment 5:

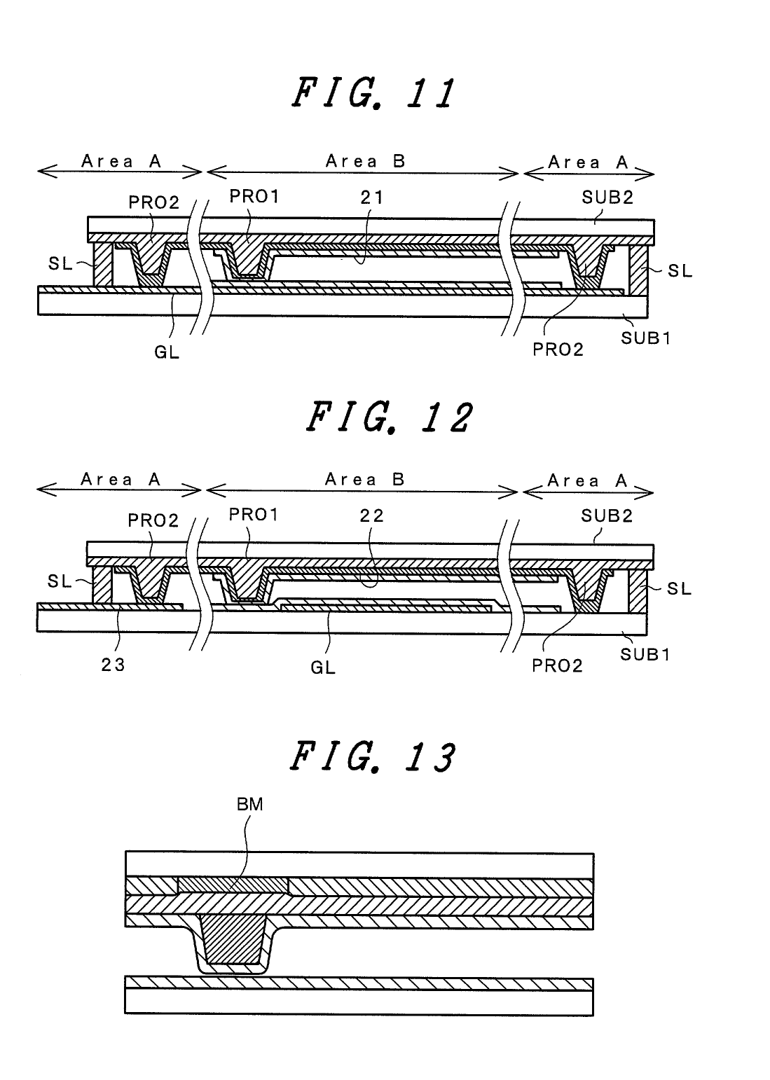

FIG. 11 is a diagram showing another embodiment of the liquid crystal display device in accordance with the present invention.

FIG. 11 depicts a sectional view of the liquid crystal display device as cut along one of respective gate signal lines GL thereof, wherein projection bodies PRO are formed on the transparent substrate SUB1 side.

And, the projection bodies PRO consist essentially of spacers (called PRO1, existing in an area B in FIG. 11) for holding a gap of respective substrates and, in particular, projection bodies PRO (called PRO2, existing in areas “A” in FIG. 11) which are disposed at the both end portions of each gate signal line GL in such a manner as to overlap or “superpose” respectively.

Further, conductive layers 21 are formed on the liquid crystal side surface of a transparent substrate SUB2 in such a manner as to overlap each gate signal line GL on the transparent substrate SUB1 side, respectively.

In this case these respective conductive layers 21 are to be formed in the state that they inevitably cover or “overcoat” a projection body PRO, resulting in establishment of electrical connection with a gate signal line GL, which is opposition-disposed at a location of this projection body PRO.

This arrangement permits the gate signal line GL to comprise bypass circuitry in addition to its inherent signal line; thus, even upon occurrence of unwanted disconnection or “open-circuiting” at the gate signal line GL, the illustrative embodiment may offer an advantage that such opencircuit is well protected by the bypass circuitry.

And, although the above-stated embodiment was explained as to protective circuitry of gate signal lines GL, it may also be applied with no substantive modifications to the case for protection of drain signal lines DL. In this case the gate signal line GL shown in FIG. 11 will be replaced with a drain signal line DL.

Additionally, although this embodiment has been explained without depicting any specific projection bodies PRO inside the seal material SL or at its nearby part, it will be needless to say that projection bodies PRO may be provided within the seal material SL or at its nearby part as in the respective embodiments stated supra.

Embodiment 6:

FIG. 12 is a diagram showing another embodiment of the type which employs a longitudinal electric field scheme of those liquid crystal display devices in accordance with the present invention.

Here, the “longitudinal electric field” scheme is the one that permits creation of electric fields between opposing or “counter” electrodes (transparent electrodes) formed on the transparent substrate SUB2 side and pixel electrodes (transparent electrodes) as formed on the transparent substrate SUB1, by way of example.

FIG. 12 is a sectional view of the liquid crystal display device as cut along one of respective gate signal lines GL thereof, wherein fixed projection bodies PRO are provided on the transparent substrate SUB2 side.

The projection bodies PRO consist essentially of projection bodies (called PRO1, existing in area B in FIG. 12) for holding a gap of respective substrates and, in particular, projection bodies (called PRO2, existing in areas A in FIG. 12) as disposed in close proximity to a seal material SL for sealing respective substrates.

The projection bodies PRO2 are designed to be formed simultaneously during fabrication of the projection bodies PROL at the fabrication process step thereof.

And, a counter electrode (transparent electrode) 22 which is common to respective pixels is formed on the liquid crystal side surface of the transparent substrate SUB2 in such a manner as to cover or coat the respective projection bodies PRO.

In addition, a conductive layer 23 that is electrically connected to the counter electrode 22 covering the projection bodies PRO2 is formed on a surface portion of the transparent substrate SUB1 which is in contact with at least one of the respective projection bodies PRO2.

This conductive layer 23 is designed to extend beyond the seal material SL at part overlying the transparent substrate SUB1 to be connected to a terminal used for supplement of a reference signal to the counter electrode 22.

Accordingly, in case the reference signal is supplied to the terminal overlying the transparent substrate SUB1, this reference signal is to be supplied through part of a projection body or bodies PRO to the counter electrode 22 on the transparent substrate SUB2 side.

The liquid crystal display device thus arranged offers an advantage that it is no longer necessary to especially provide electrical conduction means for draw-out of the counter electrode 22 onto the surface of the transparent substrate SUB1.

Note here that although this embodiment has been explained without depicting any specific projection bodies PRO inside the seal material SL or at its nearby part, it will be needless to say that projection bodies PRO may be provided within the seal material SL or at its nearby part as in the respective embodiments discussed previously.

In this case it will also be permissible to design those projection bodies PRO as formed near the seal material SL so that they function also as the aforementioned projection bodies PRO2.

Embodiment 7:

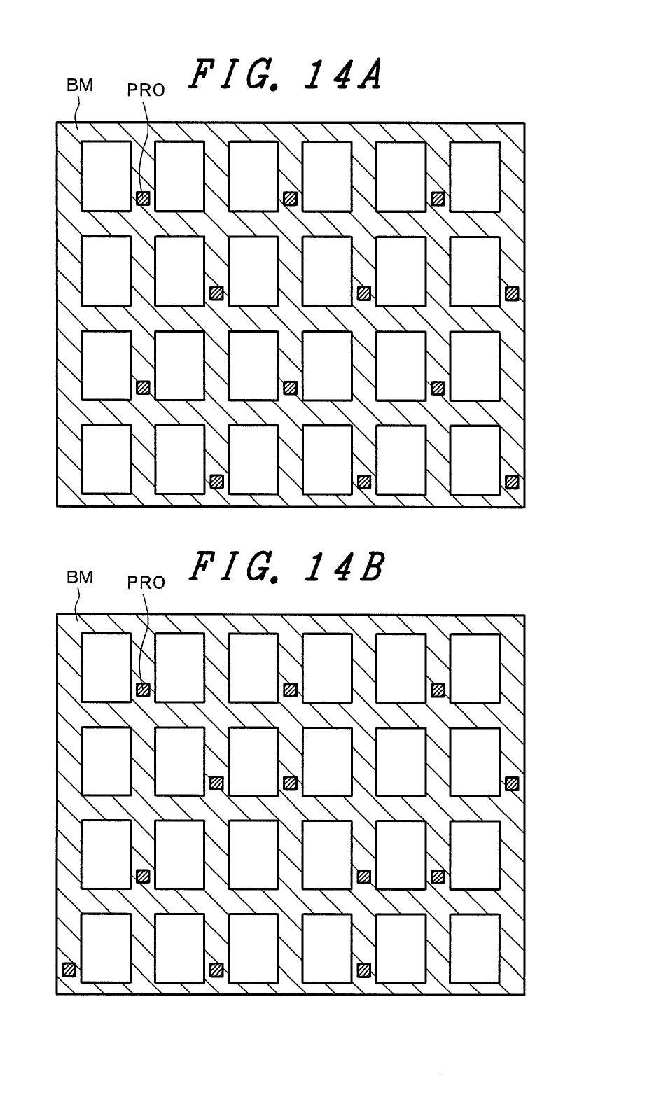

FIG. 13 is a sectional view diagram showing details of a projection body PRO which is formed and fixed to the transparent substrate SUB2 side.

A black matrix BM and more than one color filter are formed on the liquid crystal side surface of a transparent substrate SUB2, wherein a planarization film comprised of a thermally hardenable resin film is fabricated on or over their top surfaces for the purposes of flattening or “planarizing” the resultant surface thereof.

And, while this planarization film comes with a projection body PRO at its specified location, this projection body PRO is formed of an optically hardenable resin film.

Arranging the projection body PRO by using such optical hardenable resin film avoids a need to perform selective etching processes, which in turn makes it possible to reduce the requisite number of manufacturing process steps.

Additionally it would be obvious that this embodiment may be applied in the structure of each of the above-stated embodiments respectively.

Also note that this should not necessarily be limited to the transparent substrate SUB2 side and may also be applied to the case of formation on the transparent substrate SUB1 side.

Embodiment 8:

FIG. 14A is a diagram showing a pattern of projection bodies PRO that are laid out to overlie a black matrix BM for defining or “partitioning” the contour of each pixel.

While the projection bodies PRO being disposed in this manner are uniformly laid out with respect to the entire area of a display region, they are designed so that a single projection body PRO is disposed with respect to substantially the same number of mutually neighboring pixels.

This reduces the requisite number of projection bodies PRO in the display region, thereby suppressing orientation or alignment irregularities of liquid crystals otherwise occurring due to the projection bodies PRO.

Whereby, it offers an advantage as to an ability to prevent unwanted reduction of the contrast due to optical leakage (in particular, in the case of black display).

Embodiment 9:

An embodiment shown in FIG. 14B is for reduction of the number of the projection bodies PRO in the display region in a similar way to that of the embodiment 8 and is different from the embodiment 8 in that the layout thereof is not uniform but at random (non-uniform).

In light of the fact that in cases where optical leakage portions take place in a repeated pattern, such are easily recognizable by human eyes owing to the inherent characteristics of human visual senses, letting the spacers be disposed without uniformities avoids any inconvenience thereof.

Embodiment 10:

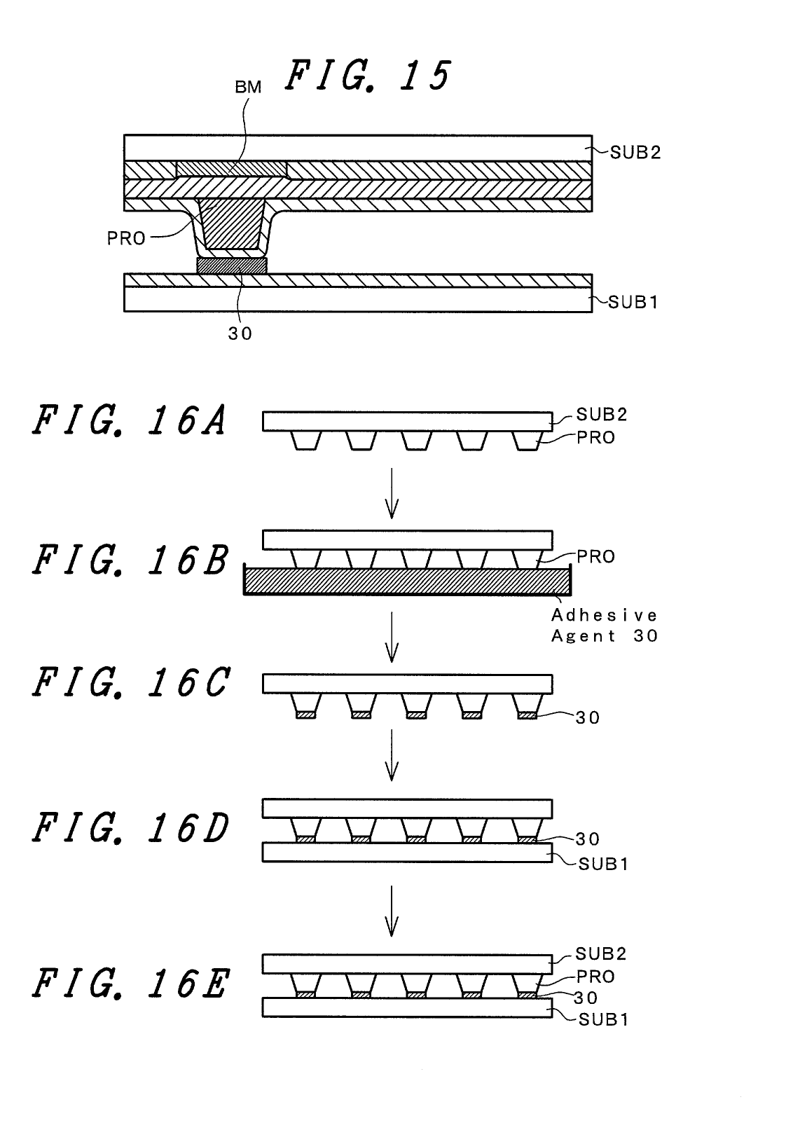

FIG. 15 is an explanation diagram showing another embodiment of the liquid crystal display device in accordance with the present invention.

In FIG. 15 a bonding adhesive 30 is interposed at an attachment section of more than one projection body PRO between a transparent substrate SUB2 with such projection body PRO fixed thereto and the remaining transparent substrate SUB1 that opposes the transparent substrate SUB 2.

The attachment section of the illustrative projection body PRO is a contact portion between alignment films, wherein these are made of the same material so that an inconvenience as to reduction of bonding forces would occur.

As a consequence, employing Si coupling agent as the adhesive 30 makes it possible to provide the reliability for definition and support of a gap between respective transparent substrates SUB1, SUB2.

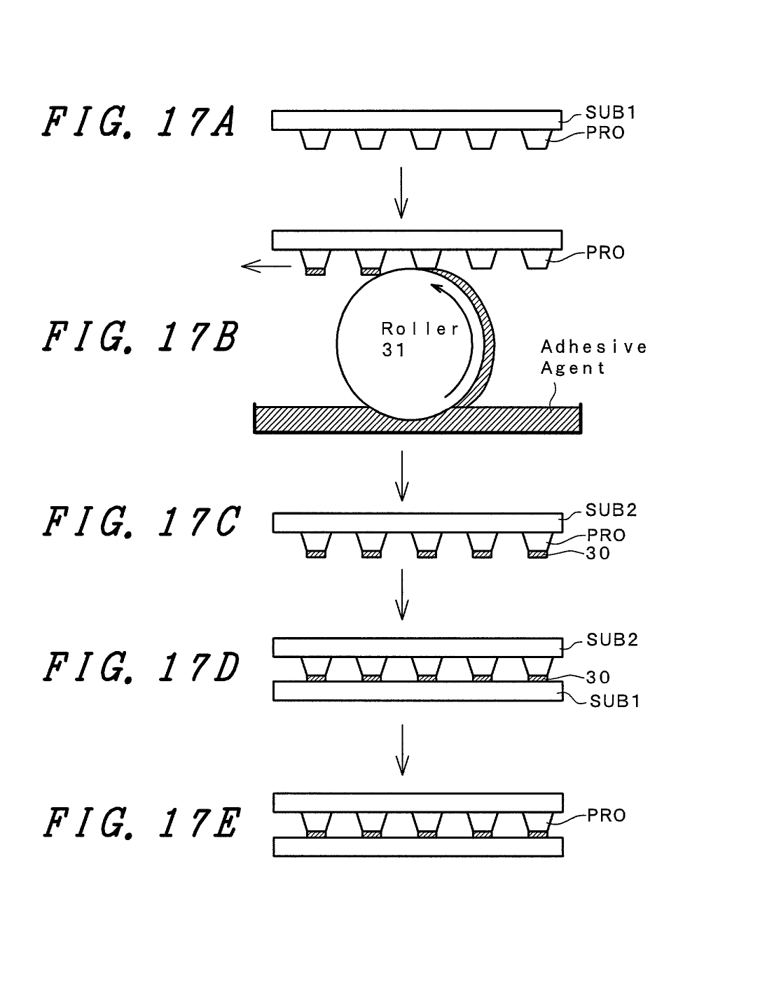

An explanation will next be given of one embodiment of a method for manufacturing the liquid crystal display device with the aforesaid arrangement with reference to FIG. 16 below.

Step 1:

Fabricate projection bodies PRO on one substrate; then, prepare the one with an alignment film formed to cover or overcoat such projection bodies PRO also (see FIG. 16A).

Step 2:

Let the substrate come closer to a vessel filled with a chosen bonding or adhesive material; then, let a surface of this adhesive 30 be in contact with top surfaces of such projection bodies PRO (FIG. 16B).

Step 3:

Whereby the adhesive 30 is deposited at the top portions of the projection bodies PRO (FIG. 16C).

Step 4:

Let the substrate be disposed to oppose a remaining substrate (FIG. 16D).

Step 5:

Apply thermal processing thereby causing the adhesive 30 to become hard. Whereby the projection bodies PRO become in the state that they are rigidly adhered to respective substrates respectively (FIG. 16E).

Another embodiment of the manufacturing method of the liquid crystal display device with the above-noted arrangement will be explained using FIG. 17.

Step 1:

Fabricate projection bodies PRO on one substrate; then, prepare the one with an alignment film formed to cover or overcoat such projection bodies PRO also (see FIG. 17A).

Step 2:

Prepare a device that comprises a roller 31 at a vessel filled with an adhesive 30; then, let adhesive components being attached to the surface of this roller 31 by means of its rotation be deposited at top portions of the projection bodies PRO (FIG. 17B).

Step 3:

Whereby the adhesive 30 is deposited at the top portions of the projection bodies PRO (FIG. 17C).

Step 4:

Let the substrate be disposed to oppose a remaining substrate (FIG. 17D).

Step 5:

Apply thermal processing thereby causing the adhesive 30 to become hard. Whereby the projection bodies PRO become in the state that they are rigidly adhered to respective substrates respectively (FIG. 17E).

Additionally it would be obvious that this embodiment may be applied in the structure of each of the above-stated embodiments respectively.

Embodiment 11:

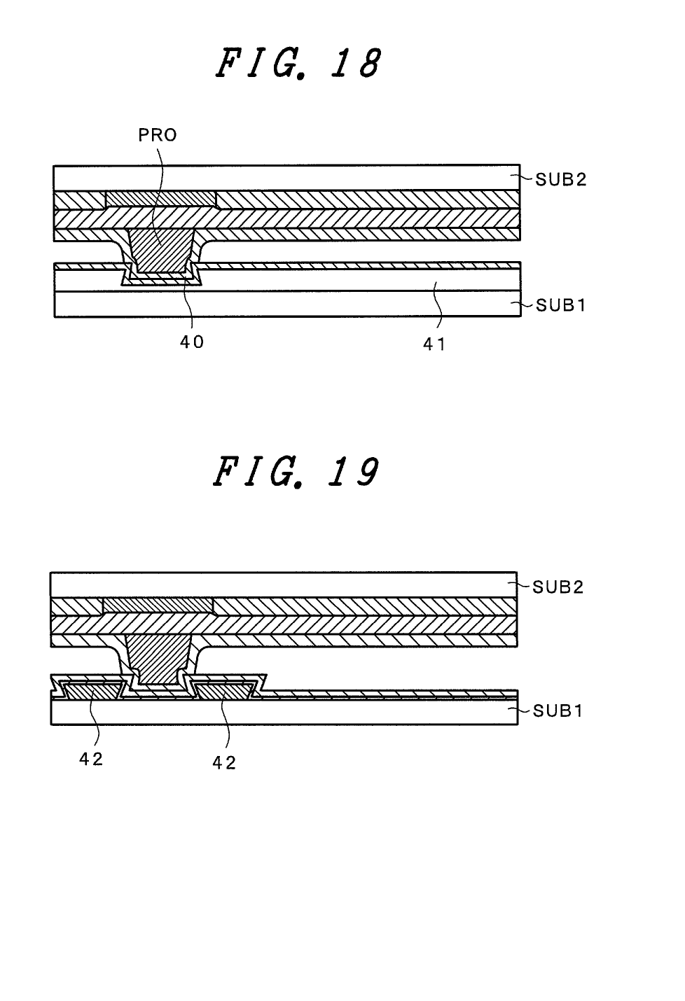

FIG. 18 is an explanation diagram showing another embodiment of the liquid crystal display device in accordance with the present invention.

This embodiment shown herein comprises a concave or recess portion 40 on the side of the other substrate opposing a substrate with more than one projection body PRO fixed thereto while letting a top portion of the projection body PRO be fitted into and mated with the recess 40.

And this recess 40 is formed in a protective film 41 on the side of a TFT substrate 1A, by way of example, to have the so-called “inverse taper”-like shape with its bottom surface side area being greater than a top surface thereof.

In the case of this arrangement, the projection body PRO is disposed so that its top portion “bites” into the recess 40, which becomes similar to the state that it is bonded to the transparent substrate SUB1.

Additionally FIG. 19 is another embodiment which is arranged while incorporating similar principles, wherein a means having similar functionality to that of the recess portion 40 is constituted from a groove between a pair of signal lines (lead wires) 42.

And, in this case, mutually opposing end portions of respective signal lines are formed into an inverse taper shape.

As apparent from the foregoing description, according to the liquid crystal display device incorporating the principles of the present invention, it is possible to perform the intended gap definition between respective transparent substrates with increased accuracy and reliability.

What is claimed is:

1. A liquid crystal display device comprising a pair of substrates as disposed to spatially oppose each other with a layer of liquid crystal material interposed therebetween and a seal material used for adhesion of one of the substrates to a remaining substrate, said seal material also having a function of encapsulating the liquid crystal material, wherein:
more than one projection body is disposed within said seal material along an extending direction thereof, and this projection body is formed at either one of said respective substrates.

2. The liquid crystal display device as recited in claim 1, wherein said projection body comprises a plurality of parallel-disposed projection bodies.

3. A liquid crystal display device comprising a pair of substrates as disposed to spatially oppose each other with a layer of liquid crystal material interposed therebetween and a seal material used for adhesion of one of the substrates to a remaining substrate, said seal material also having a function of encapsulating the liquid crystal material, wherein:
a liquid crystal encapsulation inlet port as formed at part of this seal material is sealed by a sealing material, and
said liquid crystal display device has more than one projection body being formed on one substrate side on a side with liquid crystals being encapsulated at nearby part of said liquid crystal encapsulation inlet port.

4. A liquid crystal display device comprising a pair of substrates as disposed to spatially oppose each other with a layer of liquid crystal material interposed therebetween and a seal material used for adhesion of one of the substrates to a remaining substrate, said seal material also having a function of encapsulating the liquid crystal material, wherein:
a liquid crystal encapsulation inlet port as formed at part of this seal material is sealed by a sealing material,
said liquid crystal display device has a plurality of projection bodies being formed on one substrate side on a side with liquid crystals being encapsulated at nearby part of said liquid crystal encapsulation inlet port, and
these respective projection bodies are formed to extend in a liquid crystal encapsulation direction.

5. A liquid crystal display device comprising a pair of substrates as disposed to spatially oppose each other with a layer of liquid crystal material interposed therebetween and a seal material used for adhesion of one of the substrates to a remaining substrate, said seal material also having a function of encapsulating the liquid crystal material, wherein:
a liquid crystal encapsulation inlet port as formed at part of this seal material is sealed by a UV-hardenable material,
said liquid crystal display device has more than one projection body being formed on one substrate side on a side with liquid crystals being encapsulated at nearby part of said liquid crystal encapsulation inlet port, and
this projection body is arranged to block or shield light rays coming from the liquid crystal encapsulation inlet port while guiding a flow of liquid crystals from said liquid crystal encapsulation inlet port.

6. The liquid crystal display device as recited in claim 5, wherein said projection body defines and retains a gap of the remaining substrate with respect to the one substrate.
